(19) United States
(12) Patent Application Publication
(10) Pub. No.: US 2007/0091947 A1
(43) Pub. Date: Apr. 26, 2007

(54) Laser diode drive circuit, method for controlling the same, and semiconductor integrated circuit (IC) for driving laser diode

(75) Inventors: Sang Yeal Park, Suwon-Si (KR); Kwan Joon Kim, Hwasung-Si (KR); Suk Hoon Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/370,877

(22) Filed: Mar. 9, 2006

(30) Foreign Application Priority Data
Aug. 30, 2005 (KR) 2005-79911

(51) Int. Cl. H01S 3/00

(52) U.S. Cl. 372/38.07; 372/38.02

(57) ABSTRACT

A laser diode drive circuit drives a high-power laser diode using a single voltage source and a transistor. The laser diode drive circuit includes: a voltage-level shifter shifting an output voltage of an analog signal processor to a predetermined-level voltage; a voltage adder for adding a predetermined voltage according to a record or reproduction mode of an optical disc to the level-shifted voltage; and an amplifier for amplifying a current signal of a power-supply unit in response to the added voltage and outputting the amplified current signal to a laser diode.

### CROSS-REFERENCE TO RELATED APPLICATIONS

This application claims the benefit of Korean Patent Application No. 2005-79911, filed on Aug. 30, 2005, in the Korean Intellectual Property Office, the disclosure of which is incorporated herein by reference.

### BACKGROUND OF THE INVENTION

1. Field of the Invention

An aspect of the present invention relates to a laser diode driving circuit, and more particularly to a laser diode drive circuit driving a high-power laser diode (also called a high-output laser diode) using a single voltage source and an NPN transistor.

2. Description of the Related Art

Generally, in order to reproduce data recorded in an optical disc, a current signal is applied to a laser diode to generate a laser beam, the laser beam is illuminated on the optical disc to generate reflected light, the intensity of the reflected light is detected by a photo-diode, the detected light intensity is converted into an electric signal, the electric signal is converted into a Radio Frequency (RF) signal by a reproduction signal processor, and the RF signal is read by the reproduction signal processor, such that the data recorded in the optical disc is read.

An output signal of the laser diode is changed according to a constant current caused by environmental factors such as temperature. If the output signal of the laser diode is changed, the intensity of the reflected light is also changed, resulting in difficulty in detecting data from the optical disc. Therefore, the output signal of the laser diode must be constantly maintained when data is recorded or reproduced on/from the optical disc.

In order to constantly maintain the output signal of the laser diode, a laser diode drive circuit constantly controlling the output signal of the laser diode is included in an apparatus for recording/reproducing data in/from the optical disc (hereinafter referred to as an optical recording/reproducing device). In order to constantly control the output signal of the laser diode, a feedback structure is generally formed among an optical pickup unit, an analog signal processor, and a laser diode drive. An example of a conventional laser power control device for use in the optical recording/reproducing device is disclosed in Korean Patent Laid-open No. 2000-40989. The aforementioned laser power control device includes a photodiode, a high-frequency signal detector, and a control unit controlling an input signal level of a laser diode on the basis of a variation in a high-frequency signal, such that the laser diode can constantly maintain a predetermined laser power.

FIG. 1 is a block diagram illustrating a conventional high-energy power laser diode. The conventional laser diode drive circuit converts an output voltage of a second gain control amplifier 126 of an analog signal processor into a current signal using a voltage-to-current (V/I) converter 210. In this case, a current adder 220 adds a current value differently established according to a reproduction or record mode to the current signal generated by the V/I converter 210.

A multiplexer (MUX) 230 receives a control signal from a microprocessor (not shown), and applies a current signal of a reproduction DAC (Digital-to-Analog Converter) 232 or a current signal of a record DAC 234 to the current adder 220 according to the received current signal.

The output current signal of the current adder 220 is amplified by a current amplifier 240. A High Frequency Modulation (HFM) generator 250 outputs predetermined AC waveforms of several hundreds of MHz to remove an optical interference effect from either an optical signal generated from the laser diode or an optical signal reflected from the disc. A current signal superimposed on a high-frequency signal is transmitted to an emitter terminal of a grounded base PNP transistor 260 via a capacitor 252.

The value of a voltage applied to the emitter of PNP transistor 260 is about 1V. In order to output an optical signal of a high-power laser diode, a threshold voltage must be almost double that of a diode 270 emitting a Red-ray signal, and a current signal corresponding to several tens of mA is also required, such that the current signal received from the current amplifier 240 has difficulty in satisfying the threshold voltage. Therefore, a negative voltage generator 280 generating a voltage of −5V is required to guarantee a desired laser output amount.

Conventionally, a plurality of power-supply units (5V, −5V) are required to drive the high-power laser diode, such that an additional power-supply unit is required for the power-supply voltage of −5V. Also, the V/I converter and the current amplifier are requisite components, resulting in increased production costs.

The negative voltage generator 280 requires circuit elements such as an inductor and a capacitor, such that it is difficult for a laser drive circuit to be manufactured as an integrated circuit (IC) chip. Also, a high-priced element such as a DC/DC converter is required, resulting in increased production costs.

### SUMMARY OF THE INVENTION

An aspect of the invention to provide a laser diode drive circuit for constantly maintaining an optical signal emitted from a high-power laser diode using a single power-supply unit, such that a circuit configuration is simplified and a production cost of the circuit is reduced.

According to one aspect of the invention, the above and/or other aspects can be achieved by the provision of a laser diode drive circuit comprising: a voltage-level shifter shifting an output voltage of an analog signal processor to a predetermined-level voltage; a voltage adder adding a predetermined voltage according to a record or reproduction mode of an optical disc to the level-shifted voltage; and an amplifier receiving the added voltage, amplifying a current signal of a power-supply unit, and outputting the amplified current signal to a laser diode.

The laser diode drive circuit may further include: a multiplexer (MUX) applying the predetermined voltage according to the record or reproduction mode to the voltage adder upon receiving a control signal from a controller.

The laser diode drive circuit may be driven by a single voltage source. The single voltage source may be a voltage source generating a voltage of about 6V to about 12V.

The power-supply unit providing the laser diode with a power-supply signal may transmit a predetermined voltage to the voltage-level shifter, the voltage adder, and a transistor using a single voltage source.

The amplifier receiving the added voltage may be an NPN transistor.

According to another aspect of the present invention, there is provided a method of controlling a laser diode drive circuit which outputs a drive current signal driving a laser diode contained in an optical disc record/reproduction system, the method comprising: receiving an output voltage of an analog signal processor, and shifting the received output voltage to a predetermined-level voltage; adding a predetermined voltage to the level-shifted voltage according to a record or reproduction mode of an optical disc; and receiving the added voltage, amplifying a current signal of a power-supply unit, and controlling an output operation of the drive current.

The controlling of the output operation of the drive current of the laser diode may use a single voltage source and the amplification of the current signal of the power-supply unit may be performed using an NPN transistor.

According to still another aspect of the present invention, there is provided a semiconductor integrated circuit (IC) driving a laser diode comprising: a voltage-level shifter shifting an output voltage of an analog signal processor to a predetermined-level voltage; a voltage adder adding a predetermined voltage according to a record or reproduction mode of an optical disc to the level-shifted voltage; and an amplifier receiving the added voltage, amplifying a current signal of a power-supply unit, and outputting the amplified current signal to the laser diode. The amplifier amplifying the current signal of the power-supply unit may be an NPN transistor circuit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and/or advantages of the invention will become apparent and more readily appreciated from the following description of the embodiments, taken in conjunction with the accompanying drawings of which:

FIG. 1 is a block diagram illustrating a circuit driving a conventional high-energy power laser diode;

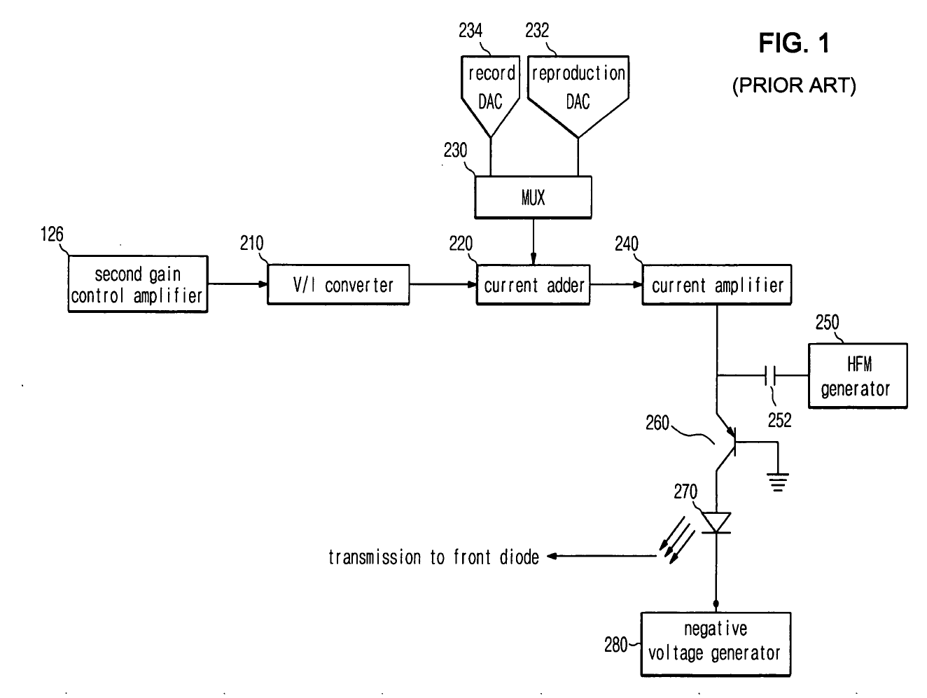

FIG. 2 is a block diagram illustrating a circuit automatically maintaining an output signal emitted from a general laser diode;

FIG. 3 is a block diagram illustrating a circuit driving a high-energy power laser diode according to an aspect of the present invention; and

FIG. 4 is a block diagram illustrating a voltage-level shifter and a voltage adder according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

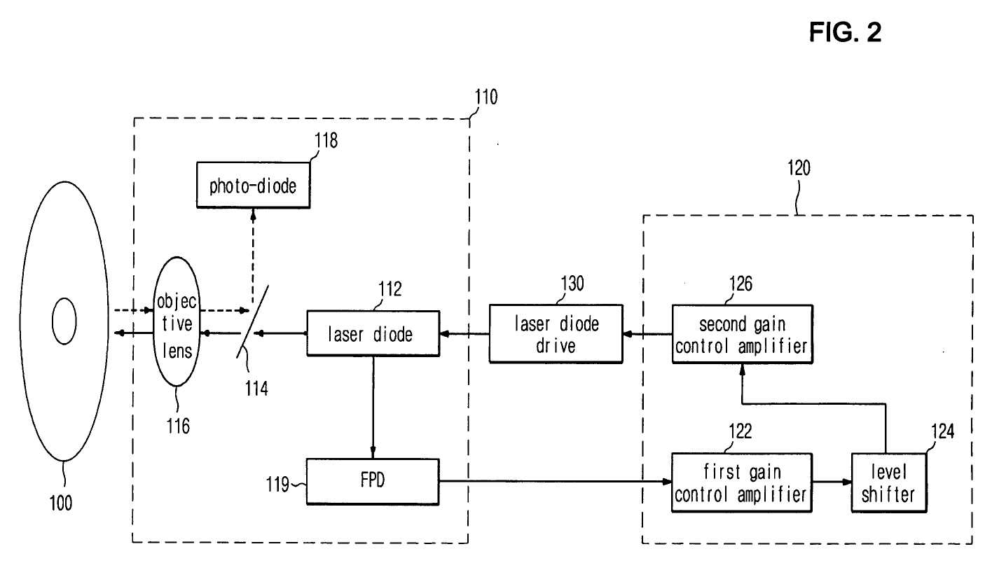

FIG. 2 is a block diagram illustrating a circuit automatically maintaining an output signal emitted from a general laser diode. The circuit shown in FIG. 2 includes a pickup unit 110, a laser diode drive circuit 130 driving a laser diode, and an analog signal processor 120.

The pickup unit 110 includes a laser diode 112 emitting a laser beam; a beam splitter 114 changing a traveling direction of an incident laser beam; an objective lens 116 arranged between the beam splitter 114 and an optical disc 100 to focus the incident laser beam on the optical disc 100; a photo-diode receiving an optical signal reflected from the optical disc 100, and converting the received optical signal into a current signal; and a Front Photo Diode (FPD) 119 receiving some parts of the laser beam emitted from the photo-diode, and converting the received laser beam parts into a light-amount voltage signal corresponding to an amount of the received laser beam. In this case, most laser beams are applied to the objective lens 116, and some laser beams are applied to the FPD 119.

The analog signal processor 120 includes a first gain control amplifier 122 receiving the light-amount voltage signal from the FPD 119, and amplifying the received light-amount voltage signal; a level shifter 124 shifting the voltage signal amplified by the first gain control amplifier 122 to a predetermined-level voltage; and a second gain control amplifier 126 amplifying the level-shifted voltage signal. A gain of the voltage signal is divisionally amplified by the gain control amplifiers 122 and 126 because a single gain control amplifier may be saturated by amplification of a large gain where a single gain control amplifier is used. The voltage signal amplified by the second gain control amplifier 126 does not reach a general threshold voltage (i.e., 4V) driving a high-power laser diode.

The laser diode drive 130 receives an output voltage signal from the second gain control amplifier 126, and transmits a drive current signal to the laser diode 112, such that the laser diode 112 is driven by the drive current signal.

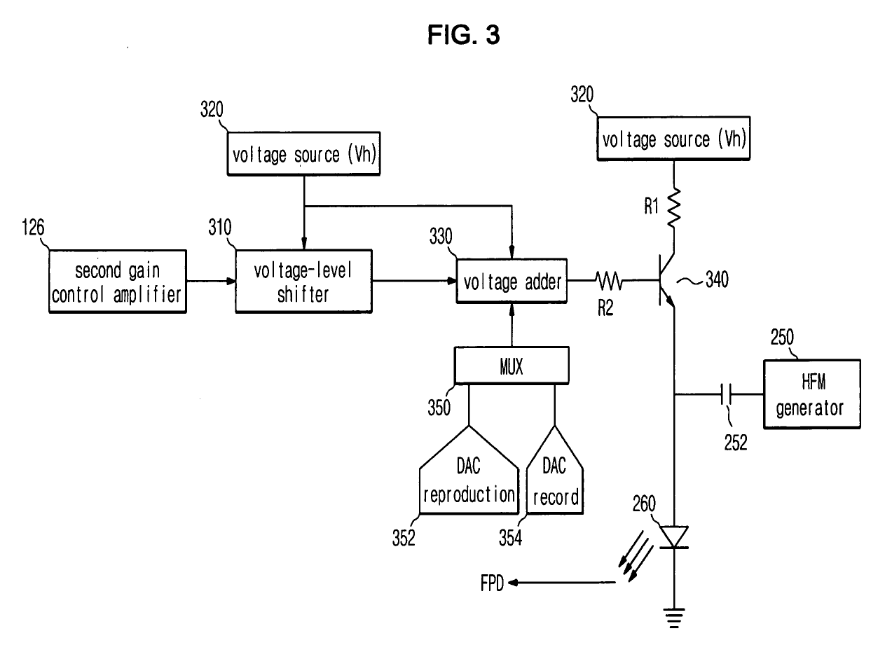

FIG. 3 is a block diagram illustrating a circuit driving a high-energy power laser diode according to an aspect of the present invention, such as for example the laser diode drive circuit shown in FIG. 2. The laser diode drive circuit includes a voltage-level shifter 310, a voltage adder 330, a multiplexer (MUX) 350, an NPN transistor 340, and a high-frequency generator 250. The voltage-level shifter 310 shifts an output voltage of the second gain control amplifier 126 to a predetermined-level voltage between zero and an output voltage of a voltage source 320. The voltage adder 330 adds a predetermined voltage for a record or reproduction operation to the level-shifted voltage generated by the voltage-level shifter 310. The multiplexer (MUX) 350 applies a predetermined voltage for the record or reproduction operation to the voltage adder 330 according to a control signal of a controller (not shown). The NPN transistor 340 receives the output voltage of the voltage adder 330 at a base terminal via a resistor R2, receives a current signal generated from a voltage source (Vh) 320 at a collector terminal via a resistor R1, amplifies a voltage signal received at the base terminal, and outputs the amplified current signal to a laser diode 260 via an emitter terminal. The high-frequency generator 250 superimposes a high-frequency signal of several hundreds of MHz via a capacitor 252 on the amplified current signal to reduce interference between the output optical signal of the laser diode and the other optical signal reflected from the optical disc 100. The voltage level shifter 310 comprises an operational amplifier 410 and associated biasing and scaling resistors (not numbered) and the voltage adder 330 comprises an operational amplifier 420 and associated biasing and scaling resistors (not numbered).

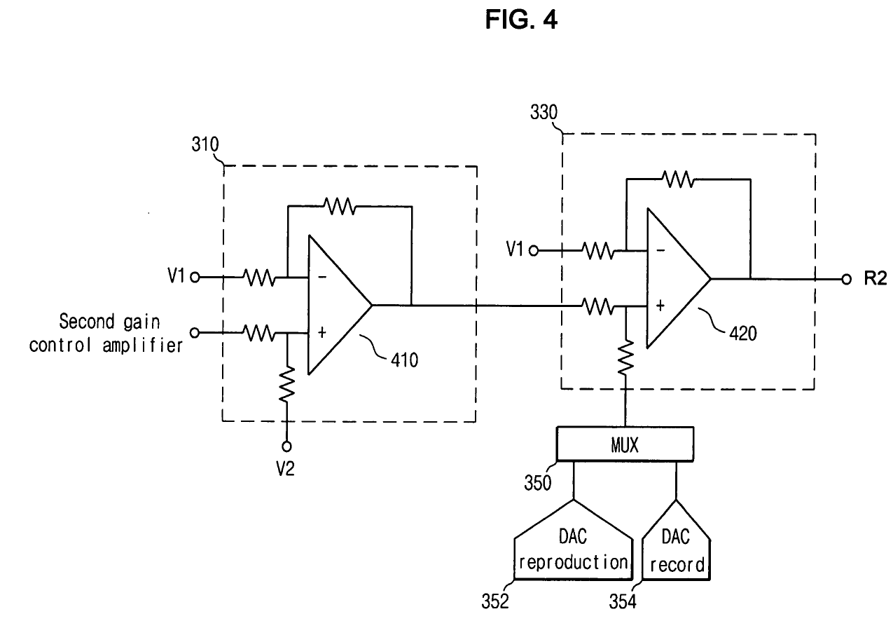

Operations of the laser diode according to aspects of the present invention will hereinafter be described with reference to FIGS. 3 and 4. Generally, the high-power laser diode requires not only a threshold voltage of 4V which is almost double that of a laser diode emitting a general Red-ray signal, but also several tens of mA, such that a current amplifier or a negative voltage generator is required for satisfying the above-mentioned threshold voltage of 4V and several tens of mA. Since the output voltage of the analog signal processor 120 does not reach a threshold voltage of the high-power laser diode, the current amplifier or the negative voltage generator is required to obtain a desired amount of light energy from the laser diode 112.

The output voltage of the analog signal processor 120 is level-shifted according to the level of a voltage used in the laser diode drive system. The shifted level is achieved by adjusting voltages of V1 and V2. Therefore, the voltages V1 and V2 can be differently determined according to a level to be shifted.

The voltage adder 330 adds different voltage values to the output voltage of the level-shifted analog signal processor 120 according to individual record/reproduction modes. The voltage adder 330 adds different voltage values to the output voltage of the level-shifted analog according to record/reproduction modes because there is a difference between a light amount generated during the record mode and a light amount generated during a reproduction mode.

The MUX 350 applies individual predetermined-amount voltage signals received from the record DAC 354 and the reproduction DAC 352 to the voltage adder 330 upon receiving a control signal from the controller (not shown).

If the voltage adder 330 generates voltage signals suitable for individual modes, a current signal is applied to a base terminal of the NPN transistor 340 via the resistor R2. In response to the base signal, the NPN transistor 340 amplifies another current signal, which is received in the collector terminal of the NPN transistor 340 via the resistor R1 to drive the laser diode of the voltage source 320, and the amplified current signal is transmitted to the laser diode via the emitter terminal of the NPN transistor 340. In this case, the voltage source is equal to a voltage source of about 6V to about 12 V higher than a conventional voltage source. A voltage higher than the threshold voltage of 4V must be applied to the laser diode to guarantee a desired output optical signal in consideration of a 1V voltage generally loaded on the NPN transistor and a voltage drop in a resistor, such that a voltage source of 5V and over must be employed. A voltage source of 6V and over is required to acquire an output optical signal of a preferable level. However, it should be noted that the lowest limit of the aforementioned voltage source can be further reduced with the development of technologies such as the development of a new laser diode. Therefore, the lowest limit of the used voltage is considered to be a minimum voltage for acquiring a desired light-output amount using a single power-supply voltage. Since a light-output amount is properly determined according to record/reproduction modes, a very high voltage applied to a laser diode is undesirable for record/reproduction operations of an optical disc. Considering a general purpose of the recording/reproducing system, a voltage of about 12V may be set to a maximum voltage. However, although a higher voltage source may be used using a limiting resistor, etc. to limit a current through the laser diode, the use of the higher voltage source is undesirable for efficiency.

As shown in FIG. 3, although the NPN transistor 340 is adapted to amplify a current signal of a voltage source, it should be noted that other circuit components (e.g., MOSFET, etc.) performing other functions can also be used. Where a junction transistor, such as the NPN transistor, is used for the transistor 340, the emitter and collector may be referred to as main terminals and the base may be referred to as a control terminal. Where a field effect transistor is used, such as for example, the MOSFET transistor, the source and drain may be referred to as the main terminals and the gate may be referred to as a control terminal. The embodiment is not necessarily limited to using an NPN transistor. For example, a PNP transistor may be used with appropriate changes in output signal levels of the voltage adder 330.

A laser beam illuminated on an optical disc and an optical signal reflected from the optical disc to read data from the optical disc use the same path, resulting in the occurrence of read data deterioration due to an interference phenomenon. In order to prevent the read data from being deteriorated, a high-frequency signal corresponding to several hundreds of MHz is generally superimposed on a drive current applied to the laser diode 260. The high-frequency signal is generated from the HFM generator 250, and is applied as a drive current to the laser diode 260 via a capacitor 252.

The laser diode 260 outputs a high-power laser beam upon receiving the drive current from the capacitor 252. Most laser beams are illuminated on the optical disc, and some laser beams are received in the FPD 119 to implement a feedback control operation.

The laser diode drive circuit according to an aspect of the present invention can drive a laser diode without using a negative voltage generator, configures a feedback circuit without using the V/I converter and the current amplifier, etc., and automatically adjusts an output optical signal of the laser diode.

FIG. 4 is a block diagram illustrating a voltage-level shifter 310 and a voltage adder 330 according to an aspect of the present invention. Referring to FIG. 4, an output voltage of a second gain control amplifier 126 of the analog signal processor 120 and a shift-level voltage V2 are received at a non-inverting terminal of the voltage-level shifter 310, and a reference voltage V1 is received at an inverting terminal of the voltage-level shifter 310, such that a DC voltage is shifted by a predetermined level, and the shifted DC voltage is generated from the voltage-level shifter 310.

The level-shifted output voltage of the voltage-level shifter 310 is received at a non-inverting terminal of the voltage adder 330. The voltage adder 330 adds voltage values of individual record/reproduction modes to the level-shifted output voltage according to a control signal of the controller (not shown), and outputs the added result to a resistor R2 connected to the base terminal of the transistor 340 as shown in FIG. 3. During the reproduction mode, a constant DC voltage is added to the level-shifted output voltage. However, during the record mode, a voltage prescribed according to record data categories is added to the level-shifted output voltage. Therefore, during the record mode, a voltage varying with data to be recorded for a very short time is applied to the voltage adder 330.

The laser diode drive circuit is driven by a single voltage source, such that it does not require a negative voltage generator 280 including an inductor. Therefore, the laser diode drive circuit can be configured on a common substrate in the form of an IC chip, such that the IC chip enables an optical disc apparatus to have a low weight and a thin profile.

As is apparent from the above description, a laser diode drive circuit is operable to maintain an output optical signal of a laser diode using a single voltage source, and does not require a negative voltage generator and a V/I converter, etc., resulting in implementation of a simple circuit configuration and reduced production costs.

In addition, a negative voltage generator is not required by the embodiments of the present invention, such that the laser diode drive circuit may be more readily included in an IC chip, etc., resulting in the implementation of a thinner manufactured product having a lower weight and production cost.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A laser diode drive circuit comprising:
a voltage-level shifter shifting an output voltage of an analog signal processor to a predetermined-level voltage;
a voltage adder adding a predetermined voltage according to a record or reproduction mode of an optical disc to the level-shifted voltage; and
an amplifier outputting an amplified current signal to a laser diode in response to the added voltage.

2. The laser diode drive circuit according to claim 1, further comprising:
a multiplexer applying the predetermined voltage according to the record or reproduction mode to the voltage adder in response to a control signal from a controller.

3. The laser diode drive circuit according to claim 1, wherein the laser diode drive circuit is driven by a single voltage source.

4. The laser diode drive circuit according to claim 3, wherein the single voltage source is a voltage of about 6V to about 12V.

5. The laser diode drive circuit according to claim 1, wherein:
the amplifier further comprises a transistor outputting the amplified current signal to the laser diode, and
a power-supply signal transmits a predetermined voltage to the voltage-level shifter, the voltage adder, and the transistor using a single voltage source.

6. The laser diode drive circuit according to claim 5, wherein the amplifier is an NPN transistor.

7. A method of controlling a laser diode drive circuit which outputs a drive current signal driving a laser diode contained in an optical disc record/reproduction system, the method comprising:
shifting an output voltage of an analog signal processor to a predetermined-level voltage;
adding a predetermined voltage to the level-shifted voltage according to a record or reproduction mode of an optical disc; and
amplifying a current signal of a power-supply unit, and controlling an output operation of the drive current.

8. The method according to claim 7, wherein the controlling of the output operation of the drive current of the laser diode uses a single voltage source.

9. The method according to claim 7, wherein the amplifying of the current signal of the power-supply unit is performed using an NPN transistor.

10. A semiconductor integrated circuit (IC) for driving a laser diode comprising:
a substrate;
a voltage-level shifter shifting an output voltage of an analog signal processor to a predetermined-level voltage;
a voltage adder adding a predetermined voltage according to a record or reproduction mode of an optical disc to the level-shifted voltage; and
an amplifier receiving the added voltage, amplifying a current signal of a power-supply unit, and outputting the amplified current signal to a laser diode, wherein:
the voltage-level shifter, the voltage adder and the amplifier are formed on the substrate.

11. The semiconductor integrated circuit (IC) according to claim 10, wherein the amplifier amplifying the current signal of the power-supply unit comprises an NPN transistor circuit.

12. A circuit for regulating power supplied to a laser diode in an apparatus for reproducing and/or recording an optical disc, the laser diode regulating circuit comprising:
a voltage-level shifter shifting an output voltage of an analog signal processor to a predetermined voltage level having a non-zero value; and
an amplifier adding a predetermined voltage to the level shifted voltage according to an operational mode of the optical disc apparatus and controlling a current through the laser diode in response to the added voltage, wherein:
the voltage-level shifter and the amplifier are both operative from a voltage source having a same polarity.

13. The laser diode regulating circuit of claim 12, wherein the amplifier further comprises:
an operational amplifier which adds the predetermined voltage and the level shifted voltage and outputs a control signal; and
a transistor having first and second main terminals and a control terminal, wherein the controlled current flows through the main terminals in response to the control signal.

14. The laser diode regulating circuit of claim 13, wherein the transistor is a junction transistor.

15. The laser diode regulating circuit of claim 13, wherein the transistor is a field effect transistor.

16. The laser diode regulating circuit of claim 12, wherein:
the predetermined voltage level for a reproducing mode of the apparatus differs from the predetermined voltage for a recording mode of the apparatus.

17. A circuit for regulating power supplied to a laser diode in an apparatus for reproducing and/or recording an optical disc, the laser diode regulating circuit comprising:
a drive circuit which:
shifts an output voltage of an analog signal processor to a predetermined voltage level having a non-zero value, and
adds a predetermined voltage to the level shifted voltage according to an operational mode of the optical disc apparatus; and
a driven circuit which controls power to the laser diode in response to the added voltage,
wherein the drive circuit and the driven circuit are both operative from a voltage source having a same polarity.

18. The laser diode regulating circuit of claim 17, wherein the driven circuit comprises a junction transistor which controls the power to the laser diode.

19. The laser diode regulating circuit of claim 17, wherein the driven circuit comprises a field effect transistor which controls the power to the laser diode.

20. The laser diode regulating circuit of claim 17, further comprising:
a multiplexer which selects a first voltage or a second voltage as the predetermined voltage, where the first voltage and the second voltage correspond to a recording mode and a reproducing mode of the apparatus, respectively.
